(19) United States
(12) Patent Application Publication
(10) Pub. No.: US 2003/0166469 A1
(43) Pub. Date: Sep. 4, 2003

(54) Crop harvesting method using a 1,2,4-triazol-1-ylpropanoic acid and derivatives

(76) Inventors: James T. Bahr, Hopewell, NJ (US); Thomas E. Hashman, West Chester, PA (US); Larry D. Hatfield, Churchville, PA (US); Henry R. Mitchell, Sturgis, MS (US)

Correspondence Address: Patent Administrator, FMC Corporation, 1735 Market Street, Philadelphia, PA, 19103, US

(21) Appl. No.: 10/320,200

(22) Filed: Dec. 16, 2002

Related U.S. Application Data
(60) Provisional application No. 60/345,371, filed on Dec. 21, 2001.

(51) Int. Cl. A01N 43/653

(52) U.S. Cl. 504/273

(57) ABSTRACT

Described herein is a method for defoliating a crop plant to aid in harvesting the crop which comprises applying to the plant an effective amount of a composition comprising one or more of a 1,2,4-triazol-1-ylpropanoic acid or derivative thereof having the formula:

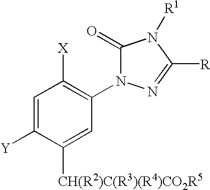

in admixture, with one or more adjuvant with an agriculturally suitable carrier, where X, Y, and R-R⁵ are described. The method is particularly effective at low use rates as an aid for harvesting cotton. Especially effective is that compound wherein X is fluoro, Y is chloro, R is methyl, R¹ is difluoromethyl, R² is hydrogen, R³ is chloro, R⁴ is hydrogen, and R⁵ is ethyl; the compound of which is carfentrazone ethyl, and the adjuvant is a crop oil concentrate.

This invention pertains generally to a method that aids in harvesting crops by application to the crop of certain compounds prior to harvest, so as to cause crop plant defoliation or crop vine desiccation. More specifically it pertains to a method that aids in harvesting crops, particularly cotton, by application of a α,2-dihalo-5-[4-(haloalkyl)-4,5-dihydro-3-alkyl-5-oxo-1H-1,2,4-triazol-1-yl]-4-halopropanoic acid, or a base addition salt thereof, or an alkyl ester thereof.

### BACKGROUND OF THE INVENTION

It is well known that the harvesting of certain crops may be aided by the use of substances that cause crop plant defoliation or crop vine desiccation. For example, cotton plant defoliation prior to harvest has several potential benefits. The removal of leaves (1) eliminates the main source of stain and trash, resulting in better grade cotton, (2) allows the cotton picker to operate faster and more efficiently, (3) allows quicker drying of dew so that picking can start earlier in the day, (4) helps straighten lodged plants for more efficient picking, (5) retards boll rot, and (6) helps stimulate boll opening. How well the cotton defoliates will often affect the yield and fiber quality of the cotton. (K. Edmisten, Center for Integrated Pest Management, North Carolina State University, via internet publication dated March, 1995).

For the harvesting of vine crops such as potatoes, plant vine desiccation is desired. Potatoes on desiccated vines are easier to harvest than those on living vines. In addition, potatoes on the killed vines are less likely to skin and bruise during harvesting. Where skinning occurs, the skinned areas of a potato are susceptible to discoloration and soft rot infection. Furthermore, skinned potatoes lose weight more rapidly and appear untidy. Examples of compounds that are commonly used as cotton plant defoliants include, without limitation, S,S,S-tributyl phosphorotrithioate, also known as butifos or Def® 6, and 1-phenyl-3-(1,2,3-thiadiazol-5-yl)urea, also known as thidiazuron or Dropp®. Compounds that are commonly used for potato vine desiccation are 1,1′-ethylene-2,2′-bipyridyldiylium ion as the dibromide monohydrate salt, also known as diquat, (±)-2-amino-4-(hydroxymethylphosphinyl)butanoic acid, also known as glufosinate, and 1,1′-dimethyl-2,2′-bipyridyldiylium ion as the dichloride salt, also known as paraquat. Among the limitations of some of these commonly used harvest aids is the need for high use rates. Thus, there is a continuing demand for new substances that promote crop plant defoliation or vine desiccation at low use rates and in a safe manner.

U.S. Pat. No. 5,125,958 describes herbicidal compounds having the formula

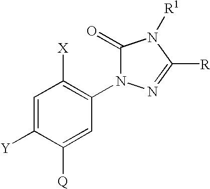

in which

R is halogen or lower alkyl;

R¹ is haloalkyl;

X is hydrogen, halogen, alkyl, alkoxyl, haloalkyl, or nitro;

Y is hydrogen, halogen, alkyl, alkoxyl, haloalkyl, halo-lower alkylsulfinyl, or halo-lower alkoxyl;

Q is CH(R²)C(R³)(R⁴)Q′ or CH═C(R⁴)Q′;

R² is hydrogen or halogen;

R³ is halogen;

R⁴ is hydrogen or lower alkyl;

Q′ is CO₂H, CO₂R⁵, CON(R⁶)(R⁷), CN, CHO, or C(O)R⁵;

R⁵ is alkyl, alkoxycarbonylalkyl, cycloalkyl, benzyl, chlorobenzyl, alkylbenzyl, or haloalkylbenzyl; and each of R⁶ and R⁷ is independently hydrogen, or a radical which is a alkyl, cycloalkyl, alkenyl, alkynyl, alkoxy, phenyl, benzyl, or SO₂R⁶ (in which R⁶ is other than hydrogen), or is one of said radicals substituted by halogen, alkyl, or cyano;

or a base-addition salt of the compound in which Q′ is CO₂H; with the proviso that any alkyl, alkenyl, or alkynyl moiety have less than 6 carbon atoms and that any cycloalkyl moiety have 3 to 7 carbon atoms.

When applied as postemergence herbicides these compounds were reported to exhibit very good control of a variety of weeds, with crop tolerance to cereal crops at low rates of application; as well as showing fungicidal acrivity against rice blast. The compounds set forth above have also shown synergistic herbicidal activity when combined with other herbicides, such as those herbicides sold under the name and trademarks of IGNITE® and HERBIACE®. The utility of these compounds as a harvest aid by causing crop plant defoliation or crop vine desiccation, either alone or in admixture with adjuvants, was not reported, or suggested in U.S. Pat. No. 5,125,958.

U.S. Pat. No. 6,444,613 describes synergistic compositions of thidiazuron, or thidiazuron and diuron and PPO inhibiting herbicides, in which the compositions are useful in effecting defoliation in plants, such as cotton. Specifically pointed out are synergistic combinations of thidiazuron, or thidiazuron and diuron and carfentrazone ethyl. Data presented therein teaches that carfentrazone tested alone only provides at best about a 29% defoliation of cotton. The use of adjuvants of any kind, to improve cotton plant defoliation with carfentrazone ethyl either alone or in admixture with other known crop defoliants, such as thidiazuron, or thidiazuron and diuron, is not reported, or suggested in U.S. Pat. No. 6,444,613.

### SUMMARY OF THE INVENTION

It has now been discovered that certain α,2-dihalo-5-[4-(haloalkyl)-4,5-dihydro-3-alkyl-5-oxo-1H-1,2,4-triazol-1-yl]-4-halopropanoic acids and derivatives thereof (hereinafter termed “1,2,4-triazol-1-ylpropanoic acids and derivatives”) of formula I below, in admixture with certain adjuvants are providing unexpectedly high levels of crop plant defoliation, which aids in the harvesting of those crops:

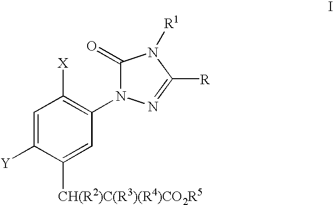

where:

R is hydrogen, or alkyl; R¹ is haloalkyl; R² is hydrogen, or halogen; R³ is halogen; R⁴ is hydrogen, or alkyl; R⁵ is hydrogen or alkyl; X is hydrogen, halogen, alkyl, haloalkyl, alkoxyl, or nitro; Y is hydrogen, halogen, alkyl, haloalkyl, alkoxyl, haloalkylsulfinyl, or haloalkoxy; or a base addition salt of the compound where R⁵ is hydrogen.

In a preferred embodiment of the invention the compound is applied in admixture with one or more adjuvants selected from crop oil (petroleum) concentrates (hereinafter termed “crop oil concentrates or concentrate”), nonionic surfactants, or alkylated seed (crop origin) oils to cotton thereby causing unexpected levels of cotton plant defoliation. The method is effective using low rates of the compound.

### DETAILED DESCRIPTION OF THE INVENTION

This invention pertains to a method for defoliating a crop plant to aid in harvesting the crop which comprises applying to the plant an effective amount of a composition comprising one or more of a 1,2,4-triazol-1-ylpropanoic acid or derivatives thereof, having the formula I:

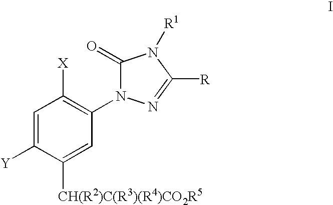

where:

R is hydrogen, or alkyl; R¹ is haloalkyl; R² is hydrogen, or halogen; R³ is halogen; R⁴ is hydrogen, or alkyl; R⁵ is hydrogen or alkyl; X is hydrogen, halogen, alkyl, haloalkyl, alkoxyl, or nitro; Y is hydrogen, halogen, alkyl, haloalkyl, alkoxyl, haloalkylsulfinyl, or haloalkoxy; or a base addition salt of the compound where R⁵ is hydrogen, in admixture with one or more adjuvants selected from crop oil concentrates, nonionic surfactants, or alkylated seed (crop origin) oils and an agriculturally suitable carrier. An effective amount of the composition is that amount sufficient to cause crop plant defoliation as described below. Preferred compounds for use in the method of the present invention are those wherein R is methyl; R¹ is difluoromethyl; X is fluoro or chloro; Y is chloro or bromo; R² and R⁴ are hydrogen, R³ is chloro; and R⁵ is alkyl. The most preferred compound is that where X is fluoro; Y is chloro; R⁵ is ethyl; and is known by the common name of carfentrazone ethyl.

The 1,2,4-triazol-1-ylpropanoic acids and derivatives of formula I are also known by the chemical name of α,2-dihalo-5-[4-(haloalkyl)-4,5-dihydro-3-alkyl-5-oxo-1H-1,2,4-triazol-1-yl]-4-halopropanoic acid and derivatives, for example, one derivative is ethyl α,2-dichloro-5-[4-(difluoromethyl)-4,5-dihydro-3-methyl-5-oxo-1H- 1,2,4-triazol-1-yl]-4-fluoropropanoate, which is carfentrazone ethyl. A representative 1,2,4-triazol-1-ylpropanoic acid and derivatives thereof useful in the present invention are shown in Table 1.

TABLE 1
Representative 1,2,4-triazol-1-ylpropanoic acids and derivatives

| | |
|---|---|
| | I |
| 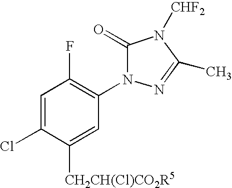 | |

| Compound No. | R⁵ |
|---|---|
| Ia | H |
| Ib | CH₃ |
| Ic | CH₂CH₃ |
| Id | CH₂CH₂CH₃ |
| Ic | CH(CH₃)₂ |
| If | (CH₂)₃CH₃ |
| Ig | CH₂CH(CH₃)₂ |
| Ih | n-pentyl |
| Ii | n-hexyl |
| Ij | Na⁺ |
| Ik | K⁺ |
| Il | Li⁺ |
| Im | Ca⁺ |
| In | NH₄⁺ |

The 1,2,4-triazol-1-ylpropanoic acid and derivatives of formula I may be prepared by the methods taught in U.S. Pat. No. 5,125,958 or by methods analogous thereto, or by methods known to one skilled in the art. A preferred 1,2,4-triazol-1-ylpropanoic acid derivative is a compound of formula I where R is ethyl (Compound Ic), which is carfentrazone ethyl.

The method of the present invention relates to a method for defoliating a crop plant comprising applying to the crop, a crop defoliating amount of a composition comprising one or more of a 1,2,4-triazol-1-ylpropanoic acid or a derivative thereof, of formula I in admixture with one or more adjuvants selected from crop oil concentrates, nonionic surfactants, or alkylated seed (crop origin) oils and an agriculturally acceptable carrier. Examples of crop oil concentrates, nonionic surfactants, and alkylated seed (crop origin) oils include, without limitation, those set forth below:

Crop Oil Concentrates

| Product Name | Manufacturer or Distributor | Principal Functioning Agent |
|---|---|---|
| ACTIVATE OIL | Drexel Chemical Co. | Paraffinic oil plus surfactant blend |
| ADJUVANT | | |
| AGICIDE | Loveland Industries | Paraffinic oil plus poly fatty acid esters and |
| ACTIVATOR | | polyethoxylated derivatives |
| AGRI-DEX | Helena Chemical Co. | Proprietary blend of heavy range paraffin base |
| | | petroleum oil polyol fatty acid esters polyethoxylated |
| | | derivatives |
| CHEM-OIL 83 | Coastal Chemical Corp. | Paraffinic oil plus emulsifiers |
| CHEM SPRAY | Chemorse, Ltd. | Paraffinic oil/surfactant blend |
| CHEM SPRAY 28N | Chemorse, Ltd. | Parafinic oil/surfactant/nitrogen solution blend |
| CITRUFILM | Helena Chemical Co. | Light to mid range paraffin base petroleum oil, polyol |
| | | fatty acid esters, and polyethoxylated derivatives |
| CLASS 17% | Class - Cenex/Land O'Lakes | Paraffinic oils plus emulsifiers |
| CONCENTRATE | | |
| CLASS CROP OIL | Class - Cenex/Land O'Lakes | Paraffinic oil plus emulsifiers |
| CONCENTRATE | | |
| CROP OIL | Helena Chemical Co. | Paraffin based petroleum oil plus polyoxyethylated |
| CONCENTRATE | | polyol fatty acid esters, and polyol fatty acid esters |
| | | (83:17) |
| CROP OIL | Royster Clark, Inc. | Paraffinic base petroleum plus blend of linear |
| CONCENTRATE | | ethoxylated alcohol |
| CROP OIL PLUS | WILFARM, L.L.C. | Paraffinic oils plus surfactant/emulsifier (83:17) |
| CROP SURF | Universal Coop. Inc. | Paraffinic oil plus emulsifiers |
| CROPTECH COC | Royster Clark/IMC- | Paraffinic petroleum oil plus surfactant/emulsifier |
| | Agribusiness | (83:17) |
| EFFECTIVE | Loveland Industries | Premium petroleum oil-surfactant with water |
| | | conditioners |
| ENSIGN | Crop Production Services | Paraffinic petroleum oil plus surfactant/emulsifier |
| | | (83:17) |
| EXCHANGE | Precision Labs, Inc. | 60-40 blend of paraffinic mineral oil and surfactants |
| FS CROP OIL PLUS | GROWMARK Inc. | Paraffinic oil plus emulsifiers |
| SURFACTANT | | |
| HERBIMAX | Loveland Industries | Paraffinic oil plus emulsifiers plus surfactants |
| HI-PER-OIL | WILFARM, L.L.C. | High load crop oil concentrate |
| MAJESTIC | Estes, Inc. | Paraffinic potroleum oil plus surfactants/emulsifiers |
| | | (83:17) |
| MAXIMIZER | Loveland Industries | Paraffinic oil plus emulsifying surfactants |
| OIL | Loveland Industries | Paraffinic oil plus emulsifiers |
| CONCENTRATE | | |
| ORTECH | Rosen's, Inc. | Paraffinic mineral oil and surfactant/emulsifier |
| | | (80:20) |
| PENETRATOR | Helena Chemical Co. | Light range paraffin based petroleum oil and polyol |
| | | fatty acid esters, and polyethoxylated derivatives |
| PENETRATOR | Helena Chemical Co. | Mid-range mineral oil, polyol fatty acid esters, |
| PLUS | | polyethoxylated ester thereof, ethoxylated alkyl |
| | | phosphate esters |
| PEPTOIL | Drexel Chemical Co. | Paraffinic base petroleum oil plus blend of linear |
| | | ethoxylated alcohol |
| PREMIUM CROP OIL | United Suppliers, Inc. | Paraffinic oil plus surfactant emulsifiers (83:17) |
| CONCENTRATE | | |
| PRIMARY | Drexel Chemical Co. | Paraffinic base petroleum oil plus blend of linear |
| | | ethoxylated alcohol |
| PRIME OIL | Riverside - Cenex/Land | Paraffin base petroleum oil and polyol fatty acid esters |
| | O'Lakes | and polyethoxylated derivatives |
| RELAY | MFA, Inc. | Paraffinic petroleum oil plus surfactant/emulsifier |
| | | (83:17) |
| R-WAY | Rosen's, Inc. | Paraffinic petroleum oil plus surfactant/emulsifier |
| | | (83:17) |
| VIGOR | Precision Labs, Inc. | 83-17 blend of paraffinic mineral oil and emulsifiers |

Non-ionic Surfactants

| Product Name | Manufacturer or Distributor | Principal Functioning Agent |
|---|---|---|
| ACTIVATE PLUS | Riverside - Cenex/Land | Alkylarylpolyoxyethylene glycols, free fatty acids |
| | O'Lakes | and IPA |
| ACTIVATOR 90 | Loveland Industries | Alkylpolyoxyethylene ethers and free fatty acids |
| ACTIVATOR N.F. | Loveland Industries | Primary aliphatic oxyalkylated alcohol, |
| | | dimethylpolysiloxane |
| AD-SPRAY 80 | Helena Chemical Co. | Alkylarylpolyalkoxylated glycols and derivatives |
| AD-SPRAY 90 | Helena Chemical Co. | Proprietary blend of alkylarylpolyalkoxylated |
| | | glycols and derivatives |
| AERO DYNE-AMIC | Helena Chemical Co. | Proprietary blend of ethoxylated alkyl phosphate |
| | | esters, polyalkylene modified polydimethylsiloxane, |
| | | nonionic emulsifiers and methylated vegetable oils |
| AGRA-WET | Loveland Industries | Surfactants: ethoxylated soybean derived and related |
| | | compounds |
| ALL PURPOSE SPRAY | Amway Corp. | Alkylarylpolyoxylated alcohols |
| ADJUVANT | | |
| APSA-80 ALL | Amway Corp. | Alkylaryl alkoxylate |
| PURPOSE | | |
| SPRAY ADJUVANT | | |
| AQUAGENE 90 | GROWMARK Inc./Universal | Alkylarylpolyoxyethylene ether, isopropanol and |
| | Coop. Inc. | free fatty acids |
| ASTUTE | INTEC | Alkylarylpolyethoxethanol, free fatty acids, 2- |
| | | buthoxy-ethanol, propylene glycol and |
| | | dimethylpolysiloxane |
| ASTUTE | MFA, Inc. | Alkylarylpolyethoxethanol, free fatty acids, 2- |
| | | buthoxy-ethanol, propylene glycol and |
| | | dimethylpolysiloxane |
| BARON | Estes, Inc. | Alkylarylpolyethoxethanol, free fatty acids, 2- |
| | | buthoxy-ethanol, propylene glycol and |
| | | dimethylpolysiloxane |
| BIG SUR 90 | Brewer International | Alkylarylpolyoxethylene glycols, free fatty acids, |
| | | isopropanol |
| BIO SURF HF | Loveland Industries | Alkylpolyethoxy ethers and ethoxylated derivatives |
| BIO-88 | Kalo, Inc. | Alkylarylpolyethoxyethanol |
| BOOST | Precision Labs, Inc. | Alkylpolyethoxy ethers and other ethoxylated |
| | | derivatives |
| CHEM-STIK | Precision Labs, Inc. | Emulsifiable polyethylene and phenox polyethethoxy |
| | | ethanol |
| CHEM-SURF | United Suppliers, Inc. | Alkylarylpolyoxyalkane ether 80%, 20% inert |
| | | ingredients |
| CHEM-SURF 90 | United Suppliers, Inc. | Alkylarylpolyoxyalkane ether IPA and free fatty |
| | | acids 90%, 10% inert ingredients |
| CHEM-WETT PLUS | Coastal Chemical Corp. | Alkylaryl polyoxyethylene glycols |
| CHEMSURF 80 | Chemorse, Ltd. | Alkylpolyoxyethylene ether and other ethoxylated |
| | | derivatives |
| CHEMSURF 90 | Chemorse, Ltd. | Alkylpolyoxyethylene, IPA and free fatty acids |
| CIDE-KICK | Brewer International | d'Limonene plus emulsifiers |
| CLASS PREFERENCE | Class - Cenex/Land O'Lakes | Alkylphenolpolyethoxylate and soybean derived |
| | | compounds and isopropanol |
| CLASS SPRAY | Class - Cenex/Land O'Lakes | Alkylphenolpolyethoxylate and isopropanol |
| BOOSTER S | | |
| COHORT DC | Helena Chemical Co. | Blend of alcohol ethoxylates and organic nitrogen |
| COVERALL | Coastal Chemical Corp. | Alkylpolyethoxy ethers |
| DPI NONIONIC | Kalo, Inc. | Block polymer of polyalkylated glycol |
| SURFACTANT | | carbonyldiamide complex |
| DYNE-AMIC | Helena Chemical Co. | Proprietary blend of phosphorylated |
| | | alkylpolyethoxylates, polyethoxlated dimethyl |
| | | siloxanes, alkylarylethoxlates and methylated seed |
| | | oils |
| 80-20 SURFACTANT | GROWMARK Inc./Universal | Alkyl polyoxyethlene ethers |
| | Coop. Inc. | |
| HOOK | Jay-Mar, Inc. | Alkylpolyoxyethylene esters, reacted amines and |
| | | aromatic petroleum solvents |
| HORIZON | Jay-Mar, Inc. | Alkylpolyoxyethylene glycols, free and modified |
| | | fatty acids, organosilicone surfactant and blended |
| | | diols |
| INDUCE | Helena Chemical Co. | Alkylarylpolyoxyalkane ether and free fatty acids |
| INDUCE PH | Helena Chemical Co. | Proprietary blend of alkylarylprolyoxylkane ethers, |
| | | alkylarylpolyethoxyethanol phosphates, free fatty |
| | | acids plus buffering agents and other components |
| INSPRAY 90 | Brandt Consolidated | Alkylarylpolyoxethylene glycol |
| INTIMIDATOR | Crop Production Services | Alkylarylpolyethoxethanol, free fatty acids, 2- |
| | | buthoxy-ethanol, propylene glycol and |
| | | dimethylpolysiloxane |
| JOINT VENTURE | Helena Chemical Co. | Proprietary blend of polyalkyleneoxide, modified |
| | | organosilicones, akylpolyoxylkane ether, and |
| | | aliphatic ester of c9-c12 fatty acids |
| LI COMBO | Loveland Industries | Phosphatidylcholine, esters of alkylpolyoxyethylene |
| | | ethers, methylacetic acid, and propyl carbinol |
| LI-700 | Loveland Industries | Phosphatidylcholine, methylacetic acid, and |
| | | alkylpolyoxyethylene ether |
| NEW BALANCE | Precision Labs, Inc. | Proprietary blend of alkyl polyethoxy ether and 2- |
| | | hydroxy-1,2,3 propane tricarboxylic acid |
| NOBILITY | Crop Production Services | Alkylarylpolyethoxethanol, free fatty acids, 2- |
| | | buthoxy-ethanol, propylene glycol and |
| | | dimethylpolysiloxane |
| PAS-800 | Drexel Chemical Co. | Phosphatidycholine, methylacetic acid and |
| | | alkypolyoxyethylene ether |
| PEN-A-TRATE II | Precision Labs, Inc. | Alkylpolyethoxy ethers and other ethoxylated |
| | | derivatives |
| PENETRON | Royster Clark, Inc. | Alkyl and alkylarylpolyoxyethylene glycol |
| PREMIUM 90 | Big Rivers Agri Supply | Alkyl and alkylarylpolyoxyethylene glycol |
| PURITY 100 | Rosen's, Inc. | Alkylarylpolyetboxyethanol, free fatty acids, 2- |
| | | buthoxy-ethanol, propylene glycol and |
| | | dimethylpolysiloxane |
| QUAD 7 | Agsco, Inc. | Propietary blend of ammonium salt, nonionic |
| | | surfactant, and buffering agent |
| R-11 | WILFARM, L.L.C. | Alkylarylpolyethoxylate and compounded silicones |
| R-56 | WILFARM, L.L.C. | Alkylarylpolyethoxylate and organic polymers |
| REGENCY | Royster Clark/IMC- | Alkylarylpolyethoxethanol, free fatty acids, 2- |
| | Agribusiness | buthoxyethanol, propylene glycol and |
| | | dimethylpolysiloxane |
| SATURALL 85 | Conklin Co., Inc. | Alkylaryl polyoxyethylene glycol, EG/PO block |
| | | copolymer, dimethylpolysiloxane |
| SENSOR PH | Riverside - Cenex/Land | Alkylpolyoxyethylene, glycol ether, |
| | O'Lakes | alkylarylpolyphosphates, phosphoric acid, and |
| | | butanol |
| SIR-FACTANT | Drexel Chemical Co. | Alkyl and alkylaryl polyoxyethylene glycol |
| SOY-WET | Loveland Industries | Ethoxylated soybean derivatives and related |
| | | compounds |
| SPREADER 90 | Loveland Industries | Alkylpolyethoxy ethers and ethoxylated derivatives |
| SPREADER HF | Loveland Industries | Alkylpolyethoxy ethers and ethoxylated derivatives |
| SURF AID | Riverside - Cenex/Land | Alkyl-polyethoxy-alkylene ethers and other |
| | O'Lakes | ethoxylated derivatives |
| SURF KING PLUS | Estes, Inc. | Alkylarylpolyethoxethanol, free fatty acids, 2- |
| | | buthoxy-ethanol, propylene glycol and |
| | | dimethylpolysiloxane |
| SURF-80 | Cannon Packaging Co. Inc. | Alkylarylpolyethoxylate and alkypolyoxyethylene |
| SURF-90 | Cannon Packaging Co. Inc. | Alkypolyethylene glycols and other ethoxylated |
| | | derivatives |
| SURF-AC 820 | Drexel Chemical Co. | Alkyl and alkylaryl polyoxyethylene glycol |
| SURF-AC 910 | Drexel Chemical Co. | Alkyl and alkylaryl polyoxyethylene glycol |
| SURFATE | Agsco, Inc. | Nonionic surfactant plus ammonium sulfate solution |
| TOPSURF | WILFARM, L.L.C. | Alkylarylpolyethoxylate ether, butanol, and free fatty |
| | | acids |
| TRADITION 93 | Rosen's, Inc. | Alkylarylpolyethoxethanol, free fatty acids, 2- |
| | | buthoxy-ethanol, propylene glycol and |
| | | dimethylpolysiloxane |
| TRANSCEND | Helena Chemical Co. | Proprietary blend of phosphorylated |
| | | alkylpolyethoxylates polyethoxylated |
| | | dimethylsiloxanes, alkylarylethoxylates, and |
| | | methylated seed oils |
| TREATY | Royster Clark/IMC- | Alkylarylpolyethoxethanol, free fatty acids, 2- |
| | Agribusiness | buthoxy-ethanol, propylene glycol and |
| | | dimethylpolysiloxane |
| TURF WETTER | Loveland Industries | Blend of proprietary surfactants |
| WEX | Conklin Co., Inc. | Alcohol ethoxylates, propylene glycol, |
| | | dimethylpolysiloxane |
| X-77 | Loveland Industries | Alkylaryloxyethylene, free fatty acids, glycols, and |
| | | isopropanol |

Methylated or Ethylated Seed Oils

| Product Name | Manufacturer or Distributor | Principal Functioning Agent |
|---|---|---|
| AERO DYNE-AMIC | Helena Chemical Co. | Proprietary blend of ethoxylated alkyl phosphate |
| | | esters, polyalkylene modified polydimethylsiloxane, |
| | | nonionic emulsifiers and methylated vegetable oils |
| AGRISTAY 87 | Ag Dynamics, Inc. | Proprietary blend of processed soybean oil and |
| | | surfactant |
| BRAS PREMIUM MSO | Big Rivers Agri Supply | Methylated seed oil plus emulsifiers |
| 1000 | | |
| CLASS DESTINY | Class - Cenex/Land O'Lakes | Methylated soybean oil plus emulsifiers |
| CONQUER | Chemorse, Ltd. | Methylated vegetable oil and surfactant blend |
| DASH HC | BASF Corp. | Blend of proprietary surfactants and oils |
| DESTINY | Riverside - Cenex/Land | Methylated seed oil plus emulsifiers |
| | O'Lakes | |
| DYNA-PAK | Helena Chemical Co. | MSO plus 28% UAN |
| DYNE-AMIC | Helena Chemical Co. | Proprietary blend of phosphorylated |
| | | alkylpolyethoxylates, polyethoxlated dimethyl |
| | | siloxanes, alkylarylethoxlates and methylated seed |
| | | oils |
| ETH-N-ATE | WILFAIRM, L.L.C. | Ethylated seed oil plus 28% N |
| HASTEN | WILFARM, L.L.C. | Ethylated seed oil plus surfactants/emulsifiers |
| HOME RUN | Conklin Co., Inc. | Methylated soybean oil plus emulsifier package |
| INSTILL | Brandt Consolidated | Methylated seed oil plus emulsifier surfactants |
| MES-100 | Drexel Chemical Co. | Methylated seed oil plus emulsifiers |
| METH OIL | Riverside - Cenex/Land | Methylated seed oil plus emulsifiers |
| | O'Lakes | |
| METH-N-OIL | Jay-Mar, Inc. | Methylated canola oil plus surfactants |
| METHOD | Loveland Industries | Methylated seed oils plus emulsifying surfactants |
| METHYLATED SEED | Kalo, Inc. | Methylated seed oil, NIS, and anti-foam agent |
| OIL | | |
| METHYLATED | GROWMARK Inc./Universal | Methylated soybean oil and surfactants |
| SOYBEAN OIL PLUS | Coop. Inc. | |
| METHYLATED-OL | Cannon Packaging Co. Inc. | Methylated seed oil with emulsifiers |
| METHYL-N | United Suppliers, Inc. | Methylated seed oil/nonionic surfactant blend 18% |
| | | 28% UAN solution 82% |
| MOMENTUM | Crop Production Services | Methylated soyoil plus surfactants and emulsifiers |
| | | (90:10) |
| MSO | Helena Chemical Co. | Proprietary blend of methylated oils and nonionic |
| | | surfactants |
| MSO CONCENTRATE | Loveland Industries | Methylated seed oils plus emulsifying surfactants |
| OIL | | |
| NOBLE | Estes, Inc. | Methylated soyoil plus surfactants/emulsifiers |
| | | (90:10) |
| PERSIST | Precision Labs, Inc. | 85-15 proprietary blend of methyl soyate, mineral |
| | | oils and surfactants |
| PERSIST EXTRA | Precision Labs, Inc. | Proprietary blend of Persist plus UAN |
| PERSIST LWV | Precision Labs, Inc. | 85-15 proprietary blend of methyl soyate, mineral |
| | | oils, and organo siloxane surfactants |
| PERSIST PLUS | Precision Labs, Inc. | Proprietary blend of Persist plus UAN |
| PHASE | Loveland Industries | Methylated seed oil plus organosilicone surfactant |
| REACT | Loveland Industries | Methylated seed oil plus water conditioners |
| RIVET | Riverside - Cenex/Land | Methylated seed oil plus organosilicone surfactant |
| | O'Lakes | |
| SCOIL | Agsco, Inc. | Methylated seed oil plus emulsifiers |
| SIL-MES 100 | Drexel Chemical Co. | Methylated seed oil plus organosilicone surfactant |
| SOLAR | Royster Clark/IMC- | Methylated soyoil plus surfactants and emulsifiers |
| | Agribusiness | (90:10) |
| SOYPLUS | MFA, Inc. | Methylated soyoil plus surfactants and emulsifiers |
| | | (90:10) |
| SPECTRUM | Coastal Chemical Corp. | Methylated seed oils plus nonionic surfactants |
| SPIRIT | Jay-Mar, Inc. | Methylated canola oil plus organosilicone surfactant |
| SUCCEED | United Suppliers, Inc. | Methylated soybean oil and surfactant blend (90:10) |
| SUN WET | Brewer International | 100% blend of methylated seed oil and emulsifiers |
| SUNDANCE HC | Rosen's, Inc. | Proprietary blend of surfactants plus oils |
| SUNDANCE II | Rosen's, Inc. | Methylated soyoil plus surfactants and emulsifiers |
| | | (90:10) |
| SUN-IT II | Agsco, Inc. | Methylated seed oil plus emulsifiers |
| SUPERB | WILFARM, L.L.C. | Methylated vegetable oil plus surfactants / |
| | | emulisifiers |
| TRANSCEND | Helena Chemical Co. | Proprietary blend of phosphorylated |
| | | alkylpolyethoxylates polyethoxylated |
| | | dimethylsiloxanes, alkylarylethoxylates, and |
| | | methylated seed oils |

Although preferred adjuvants are selected from one or more of a crop oil concentrate, a nonionic surfactant, or a alkylated seed (crop origin) oil, it is expected that one or more other commercially-available adjuvants would also be useful in compositions of the present invention as aids in harvesting crops. Such adjuvants include, without limitation, surfactants plus a nitrogen source, organo-silicone surfactants, crop oil (petroleum) concentrates plus a nitrogen source, deposition and retention agents, deposition and retention agents plus ammonium sulfate, compatibility agents, buffering agents and acidifiers, antifoam agents, foam markers, and other adjuvants. In a more preferred embodiment the adjuvant is selected from crop oil concentrates, and the crop is cotton. The cotton crop whose harvest is benefited by use of the compositions of the present invention may be cotton grown on any variety of cotton plants, to include genetically modified (transgenic) cotton plants.

A preferred crop oil concentrate in the context of the present invention is comprised of at least 60% by weight of a paraffinic petroleum oil base and at least 10% by weight of surfactants, emulsifiers, and mixtures of surfactants and emulsifiers. More preferably, the crop oil concentrate is comprised of paraffinic petroleum oil in the range of about 80% to about 85% by weight, and surfactants, emulsifiers, and mixtures of surfactants and emulsifiers in the range of about 15% to about 20% by weight. Crop oil concentrates are available from commercial sources, as set forth above.

The compositions of the present method are prepared by combining formulations of effective amounts of a 1,2,4-triazol-1-ylpropanoic acid or derivatives with, for example, crop oil concentrates. The formulations of 1,2,4-triazol-1-ylpropanoic acid or derivatives are comprised of different adjuvants and carriers normally employed in the art for facilitating the dispersion of active ingredients for the particular utility desired, recognizing the fact that the formulation and mode of application of the harvest aid may affect its activity in a given application. Useful formulations include, but are not limited to, granules, emulsifiable dry flowables, concentrates, emulsifiable flowables, solutions, dispersions, wettable powders, suspensions, and suspension concentrates. A typical dry flowable formulation consists of the following:

| Component | Weight Percent |
|---|---|
| Active ingredient | 40.0 |
| Amorphous and quartz silica blend | About 29.4 |
| Lignosulfonate acid, sodium salt | About 12.0 |
| Alkypolyglycoside | About 1.2 |
| Diluent | About 17.4 |

For an effective amount of a composition to cause crop plant defoliation, the amount of a 1,2,4-triazol-1-ylpropanoic acid or derivatives thereof that may be used in a composition of the present invention is in the range of about 0.0011 kilogram to about 0.1120 kilogram of technical material per hectare (about 0.001 Lb/A to about 0.100 Lb/A). A preferred effective amount of the composition to cause crop plant defoliation is in the range of about 0.006 to about 0.06 Kg/Ha (0.005 to about 0.050 Lb/A); more preferably in the range of about 0.008 Kg/Ha to about 0.04 Kg/Ha (0.007 to about 0.035 Lb/A). Adequate defoliation may usually be achieved from a single application of the formulated 1,2,4-triazol-1-ylpropanoic acid or derivatives, however, more than one application may be needed to obtain the degree of defoliation needed for efficacious crop harvest.

An effective amount of adjuvant, the amount, for example, of a crop oil concentrate that may be used in a composition of the present invention is in the range of about 0.1% to about 10% by volume of the composition. A preferred effective amount of a crop oil concentrate is in the range of about 0.3% to about 5% by volume of the composition, and, more preferably, about 0.5% to about 2.5% by volume.

When the harvest aid is applied to achieve crop defoliation, as for example in the harvesting of cotton, the timing of defoliation is important. The proper timing of application of a defoliant is within the knowledge of one skilled in the art. For example, decisions for when to apply the harvest aid to cotton are typically based on such factors as the maturity of the cotton bolls and/or the percent of bolls that are open or unopen. Defoliation that occurs too early may result in lower yield. Defoliation that occurs too late may increase the chance of boll rot and may be less effective as a result of lower temperatures. Under normal conditions, it is generally safe to defoliate when about thirty to eighty-five percent of the bolls are open, preferably when about sixty percent of the bolls are open. The crop may then be harvested after about seven to twenty-one days after application of defoliant.

The present method is very effective as a harvest aid with regard to crop defoliation, for example, without limitation, in the harvest of potatoes and cotton. In particular, the method is very effective for cotton. The method of the present invention may also benefit crop harvest by defoliation of certain weeds found in a locus of where crops are grown. The efficacy of the 1,2,4-triazol-1-ylpropanoic acids and derivatives, in admixture with a crop oil concentrate is shown below in the comparative testing of, for example, Compound Ic, either alone or in combination, with commercial cotton plant defoliating standards.

The following examples further illustrate the present invention, but, of course, should not be construed as in any way limiting its scope. The examples set forth certain biological data illustrating the efficacy of the compositions of the present invention in defoliating crops such as cotton. Unless otherwise indicated, all parts, percentages, and the like are by weight.

### EXAMPLE 1

Cotton Plant Defoliation

Cotton plant defoliation activity was determined as follows. An appropriate amount of AIM® 40 DF HERBICIDE formulation of Compound Ic (carfentrazone ethyl) was dissolved in sufficient water to provide rates of application of about 0.014 Kg/Hectare (0.0125 lb/A) and 0.017 Kg/Hectare (0.015 lb/Acre) when sprayed using a small plot sprayer at a delivery rate in the range of 90-280 liters per hectare to the foliage of cotton in which 30-85% of the bolls were open. Solutions of Compound Ic sprayed onto the foliage contained 1% (v/v) of a crop oil concentrate comprised of about 80% to about 85% by weight of a paraffinic petroleum oil and about 15% to about 20% by weight of surfactants and emulsifiers. In addition, some of the solutions of Compound Ic and the crop oil concentrate were combined with solutions of known crop defoliants, such as PREP™ Brand Ethephon; FINISH® Brand 4 Harvest Aid For Cotton; DROPP® 50 WP DEFOLIANT; GINSTAR® EC DEFOLIANT; DEF® EMULSIFIABLE DEFOLIANT; ACTION™ HERBICIDE; STARFIRE™ HERBICIDE; and HARVADE® 5F. The known defoliants were also tested individually and together in combination with a crop oil concentrate. There were a number of replicates for each rate of application wherein each replicate was sprayed onto two to four rows of cotton in a plot size of about 35 square meters or less. The test was conducted in a randomized complete block design. The cotton test plots were assessed for percent defoliation at 4 or 7 and 13 or 14 days after treatment. Tables 1, 2, and 3 below show the results of the defoliation tests conducted in different locations. A test was also conducted in a similar manner with AIM® 40 DF HERBICIDE plus PREP™ Brand Ethephon alone and in combination with a crop oil concentrate, and also in combination with a nonionic surfactant. Table 4 shows the results of that test

TABLE 1
Defoliation Of Cotton Plants As An Aid To Harvesting

| | | Percent Defoliation | |
|---|---|---|---|
| Formulation | Rate of Application | 7 Days After | 13 Days After |
| Applied | (Kg/Ha) | Treatment | Treatment |
| 1 + 2 | 0.014 + 1% (v/v) | 71.7 | 87.7 |
| | 0.017 + 1% | 73.3 | 94.7 |
| 1 + 3 + 2 | 0.014 + 0.84 + 1% | 81.7 | 93.7 |
| | 0.014 + 1.12 + 1% | 71.7 | 90.0 |
| | 0.017 + 0.84 + 1% | 78.3 | 91.3 |
| | 0.017 + 1.12 + 1% | 83.3 | 92.7 |
| 1 + 3 + 2 | 0.017 + 1.12 + 1% | 83.3 | 96.7 |
| 1 + 2* | 0.017 + 1% | | |
| 1 + 4 + 2 | 0.014 + 0.84 + 1% | 80.0 | 91.3 |
| | 0.017 + 0.84 + 1% | 86.7 | 95.3 |
| 3 + 8 + 2 | 1.12 + 0.84 + 1% | 83.3 | 90.7 |
| 4 + 2 | 0.84 + 1% | 73.3 | 88.0 |
| 9 + 2 | 0.005 + 1% | 86.7 | 96.0 |
| 9 + 3 + 2 | 0.005 + 1.12 + 1% | 81.7 | 96.3 |
| 9 + 2* | 0.005 + 1% | | |
| 10 + 2 | 0.28 + 1% | 41.7 | 61.7 |
| 10 + 2* | | | |
| Untreated | — | 0 | 0 |
| Control | | | |

*1 + 2; 9 + 2; and 10 + 2 were applied seven days after the initial application of 1 + 3 + 2; 9 + 3 + 2; and 10 + 2, respectively.

TABLE 2
Defoliation Of Cotton Plants As An Aid To Harvesting

| | | Percent Defoliation | |
|---|---|---|---|
| Formulation | Rate of Application | 7 Days After | 14 Days After |
| Applied | (Kg/Ha) | Treatment^{a} | Treatment^{a} |
| 1 + 2 | 0.014 + 1% (v/v) | 87.5 | 97.8 |
| | 0.017 + 1% | 81.3 | 94.3 |
| 1 + 3 + 2 | 0.014 + 0.84 + 1% | 87.5 | 96.5 |
| | 0.014 + 1.12 + 1% | 86.3 | 95.8 |
| | 0.017 + 0.84 + 1% | 95.0 | 96.3 |
| | 0.017 + 1.12 + 1% | 85.0 | 94.5 |
| 1 + 3 + 2 | 0.017 + 1.12 + 1% | 93.8 | 98.5 |
| 1 + 2* | 0.017 + 1% | | |
| 4 + 2 | 0.84 + 1% | 86.3 | 91.5 |
| 1 + 4 + 2 | 0.014 + 0.84 + 1% | 93.8 | 97.0 |
| | 0.017 + 0.84 + 1% | 95.0 | 96.8 |
| 3 + 8 + 2 | 1.12 + 0.84 + 1% | 93.8 | 96.3 |
| 9 + 2 | 0.005 + 1% | 73.8 | 92.5 |
| 9 + 3 + 2 | 0.005 + 1.12 + 1% | 95.0 | 96.3 |
| 9 + 2* | 0.005 + 1% | | |
| 10 + 2 | 0.28 + 1% | 62.5 | 84.5 |
| 10 + 2* | 0.28 + 1% | | |
| Untreated | — | 57.5** | 60.0** |
| Control | | | |

*1 + 2; 9 + 2; and 10 + 2 were applied seven days after the initial application of 1 + 3 + 2; 9 + 3 + 2; and 10 + 2, respectively.
**Note:
Since cotton defoliates on its own accord without treatment, it is not unusual to observe defoliation in the untreated control.

TABLE 3
Defoliation Of Cotton Plants As An Aid To Harvesting

| | | Percent Defoliation | |
|---|---|---|---|
| Formulation | Rate of Application | 7 Days After | 13 Days After |
| Applied | (Kg/Ha) | Treatment | Treatment |
| 1 + 2 | 0.014 + 1% (v/v) | 78.3 | 86.7 |
| | 0.017 + 1% | 83.3 | 91.3 |
| 1 + 5 + 2 | 0.014 + 0.11 + 1% | 85.0 | 95.0 |
| | 0.017 + 0.11 + 1% | 91.7 | 96.0 |
| 3 + 5 + 2 | 1.12 + 0.11 + 1% | 75.0 | 83.7 |
| 6 + 2 | 0.11 + 1% | 80.0 | 95.5 |
| 1 + 6 + 2 | 0.014 + 0.11 + 1% | 85.0 | 96.0 |
| | 0.017 + 0.11 + 1% | 92.0 | 97.0 |
| 7 + 2 | 0.35 + 1% | 43.3 | 48.3 |
| 1 + 7 + 2 | 0.014 + 0.35 + 1% | 90.0 | 95.0 |
| | 0.017 + 0.35 + 1% | 80.0 | 90.3 |
| Untreated | — | 3.3 | 0 |
| Control | | | |

TABLE 4
Defoliation Of Cotton Plants As An Aid To Harvesting

| | | Percent Defoliation | |
|---|---|---|---|
| Formulation | Rate of Application | 4 Days After | 14 Days After |
| Applied | (Kg/ha) | Treatment | Treatment |
| 1 + 3 | 0.018 + 0.84 | 0 | 0 |
| 1 + 3 + 2 | 0.018 + 0.84 + 1% | 50 | 65 |
| 1 + 3 + 11 | 0.018 + 0.84 + 0.25% | 40 | 72 |
| Untreated | — | — | — |
| Control | | | |

1) The active ingredient (ai) is carfentrazone ethyl, sold under the name and trademark of AIM ® 40 DF HERBICIDE, by FMC Corporation, Philadelphia, PA
2) COC is a generic crop oil concentrate comprised of 80-85% (wt/wt) of a paraffinic petroleum oil base and 15-20% (wt/wt) of surfactants/emulsifiers.
3) The ai is ethephon (55.4% wt/wt), sold under the name and trademark PREP ™ Brand Ethephon For Cotton and Tobacco, by Aventis Crop Science USA LP. .
4) The ai's are a mixture of ethephon (35.1% wt/wt) and cyclanilide (4.3%), sold under the name and trademark of FINISH ® Brand 4 Harvest Aid For Cotton, by Aventis Crop Science USA LP.
5) The ai is thidiazuron (50% wt/wt), sold under the name and trademark of DROPP ® 50 WP DEFOLIANT, by Aventis Crop Science USA LP.
6) The ai's are a mixture of thidiazuron (12% wt/wt) and diuron (5 %), sold under the name and trademark of GINSTAR ® EC DEFOLIANT, by AgrEvo USA.
7) The ai is dimethipin (48% wt/wt), sold under the name and trademark of HARVADE ® 5F, by Uniroyal Chemical Company.
8) The ai is tribufos (70.5% wt/wt), sold under the name and trademark of DEF ® EMULSIFIABLE DEFOLIANT, by Bayer Corporation.
9) The ai is fluthiacet-methyl (10.3% wt/wt), sold under the name and trademark of ACTION ™ HERBICIDE, by Novartis Crop Protection, Inc.
10) The ai is paraquat dichloride (23.3% wt/wt), sold under the name and trademark of STARFIRE ® HERBICIDE, by Syngenta Crop Protection, Inc.
11) NIS is a non-ionic surfactant.

The results in Tables 1, 2, and 3 show that a composition of the present invention, comprised of Compound Ic and a crop oil concentrate, is unexpectedly highly effective as a cotton plant defoliant. When comparing the results of tests of a composition of the present invention, i.e., Formulation 1+(2), with tests of formulations of known cotton plant defoliants, such as ethepon plus cyclanilide (Formulation 4), thidiazuron plus diuron (Formulation 6), and dimethipin (Formulation 7), all in combination with a crop oil concentrate (2), it can be seen that a composition of the present invention is equally as, or more effective than, the known defoliants in the defoliation of cotton plants, but generally at much lower rates of application.

For example in Tables 1, 2, or 3, a composition of the present invention (1+2) provided 86.7% to 97.8% defoliation of cotton plants at 13-14 days after treatment (DAT) at a rate of application of 0.014 Kg/Ha, whereas Formulation 4 plus (2) provided 88% to 91.5% defoliation of cotton plants at 13 DAT at a rate of 0.84 Kg/Ha; Formulation 6 plus (2) provided 95.5% defoliation of cotton plants at 13 DAT at a rate of application of 0.11 Kg/Ha, and Formulation 7+(2) provided 48.3% defoliation of cotton plants at 13 DAT at a rate of application of 0.35 Kg/Ha. In these tests, Formulation 9 plus (2) provided 92.5 % to 96% defoliation of cotton plants at 13 14 DAT at a rate of application of 0.005 Kg/Ha.

When the compositions of the present invention were combined with certain formulations of known cotton plant defoliants as set forth above, improved, earlier cotton plant defoliation was observed when compared to cotton plant defoliation of the compositions of the present invention tested alone.

For example, a composition of the present invention provided 71.7% to 87.5% cotton plant defoliation at 7 DAT. Formulation 1 plus Formulation 3 (ethephon) plus (2) provided 71.7% to 95% cotton plant defoliation; Formulation 1 plus Formulation 4 (ethepon/cyclanilide) plus (2) provided 80% to 95% cotton plant defoliation; Formulation 1 plus Formulation 5 (thidiazuron) plus (2) provided 85% to 91.7% cotton plant defoliation; Formulation 1 plus Formulation 6 (thidiazuron/diuron) plus (2) provided 85% to 92% cotton plant defoliation; and Formulation 1 plus Formulation 7 (dimethipin) plus (2) provided 80% to 90% cotton plant defoliation; all at 7 DAT.

In some cases, the combination of the compositions of the present invention and a composition of a known cotton plant defoliant provided improved cotton plant defoliation over that provided by the individual compositions tested alone.

For example, a composition of the present invention provided 78.3% cotton plant defoliation at 7 DAT, and Formulation 7 plus (2) provided 43.3% cotton plant defoliation at 7 DAT. When the two compositions were combined, 90% cotton plant defoliation was realized. Similar results were obtained in tests of the compositions of the present invention and other known cotton plant defoliants. The increase in cotton defoliation by such combinations of compositions of the present invention, comprised of Compound Ic and a crop oil concentrate, and known cotton plant defoliants is clearly unexpected.

In Table 4, when the combination of Compound Ic and Ethephon was tested without the crop oil concentrate, there was no defoliation of cotton. When a crop oil concentrate was added to the aforementioned combination, there was at least 50% cotton plant defoliation. When the crop oil concentrate was replaced with a nonionic surfactant, there was at least 40% cotton plant defoliation.

The modifier “about” is used herein to indicate that certain preferred operating ranges, such as ranges for molar ratios for reactants, material amounts, temperature, and rates of application of a herbicide to a locus where a herbicide is needed are not fixedly determined. The meaning will often be apparent to one of ordinary skill. For example, a recitation of a rate of application in the range of about 0.006 to about 0.06 Kg/Ha would be interpreted to include other like rates of application that can be expected to favor a useful rate of application of herbicide, such as 0.005 Kg/HA or 0.07 Kg/HA. Where guidance from the experience of those of ordinary skill is lacking, guidance from the context is lacking, and where a more specific rule is not recited below, the “about” range shall be not more than 10% of the absolute value of an end point or 10% of the range recited, whichever is less.

As used in this specification and unless otherwise indicated the substituent terms alkyl, haloalkyl, alkoxyl, and haloalkoxyl used alone or as part of a larger moiety, includes straight or branched chains of at least one or two carbon atoms, as appropriate to the substituent, and preferably up to 12 carbon atoms, more preferably up to ten carbon atoms, most preferably up to seven carbon atoms. “Halogen” or “halo” refers to fluorine, bromine, iodine, or chlorine.

The term “desiccant” refers to a material that has the capability to dry up, cause to dry up, deprive, or exhaust the moisture in certain crop vines; whereas the term “desiccating” refers to the process of drying up, causing to dry up, depriving, or exhausting the moisture in certain crop vines using a desiccant.

The term “defoliant” refers to a material that has the ability to cause the leaves of certain crop plants to fall off prematurely; whereas the term “defoliating” refers to the process of causing the leaves of certain crop plants to fall off prematurely using a defoliant.

The term “adjuvant” refers to a material added to a mix of, for example, a formulation of an agrichemical, such as carfentrazone ethyl, to aid or modify the action of the agrichemical, or the physical characteristics of the mixture.

Those of ordinary skill in the art will appreciate that variations of the invention may be used and that it is intended that the invention may be practiced otherwise than as specifically described herein. Accordingly, this invention includes all modifications encompassed within the spirit and scope of the invention as defined by the following claims.

What is claimed is:

1. A method for defoliating a crop plant to aid in harvesting said crop, which comprises applying to the plant an effective amount of a composition comprising one or more of a 1,2,4-triazol-1-ylpropanoic acid or derivative thereof, having the formula: 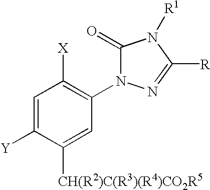
where:
R is hydrogen, or alkyl; R¹ is haloalkyl; R² is hydrogen, or halogen; R³ is halogen; R⁴ is hydrogen, or alkyl; R⁵ is hydrogen or alkyl; X is hydrogen, halogen, alkyl, haloalkyl, alkoxyl, or nitro; Y is hydrogen, halogen, alkyl, haloalkyl, alkoxyl, haloalkylsulfinyl, or haloalkoxy; or a base addition salt of the compound where R⁵ is hydrogen, in admixture with one or more of a crop oil concentrate, and an agriculturally suitable carrier.

2. A method of claim 1, wherein R is methyl; R¹ is difluoromethyl; X is fluoro or chloro; Y is chloro or bromo; R² and R⁴ are hydrogen, R³ is chloro; and R⁵ is alkyl.

3. A method of claim 2, wherein X is fluoro; Y is chloro; and R⁵ is ethyl.

4. A method of claim 1, wherein said crop plant is cotton.

5. A method of claim 1, wherein said effective amount of said composition is in the range of about 0.0011 kilogram per hectare to about 0.1120 kilogram per hectare.

6. A method of claim 5, wherein said effective amount is in the range of about 0.006 kilogram per hectare to about 0.06 kilogram per hectare.

7. A method of claim 6, wherein said effective amount is in the range of about 0.008 kilogram per hectare to about 0.04 kilogram per hectare.

8. A method of claim 1, wherein said crop oil concentrate is comprised of at least 60% by weight of a paraffinic petroleum oil and at least 10% by weight of surfactants, emulsifiers, and mixtures of surfactants and emulsifiers.

9. A method of claim 8, wherein said paraffinic petroleum oil is in the range of about 80% by weight to about 85% by weight and said surfactants, emulsifiers, and mixtures of surfactants and emulsifiers is in the range of about 15% to about 20% by weight of said crop oil concentrate.

10. A method of claim 1, wherein said composition is comprised of about 0.1% to about 10% by volume of said crop oil concentrate.

11. A method of claim 10, wherein said composition is comprised of about 0.3% to about 5% by volume of said crop oil concentrate.

12. A method of claim 11, wherein said composition is comprised of about 0.5% to about 2.5% by volume of said crop oil concentrate.

13. A method of claim 1, wherein i) said 1,2,4-triazol-1-ylpropanoic acid derivative is carfentrazone ethyl, ii) said crop plant is cotton, iii) said effective amount is in the range of about 0.0011 kilogram per hectare to about 0.1120 kilogram per hectare, and iv) said composition is comprised of about 0.5% to about 2.5% by volume of said crop oil concentrate.

14. A method of claim 1, wherein said composition is further comprised of at least one or more other crop plant defoliants selected from ethephon, cyclanilide, thidiazuron, diuron, dimethipin, tribufos, and mixtures thereof.

15. A method of claim 13, wherein said composition is further comprised of at least one or more other crop defoliant selected from ethephon, cyclanilide, thidiazuron, diuron, dimethipin, tribufos, and mixtures thereof.

16. A method of claim 1, wherein said crop plant is defoliated by application of said composition.

17. A method of claim 13, wherein said crop plant is defoliated by application of said composition.

18. A method of claim 14, wherein said crop plant is defoliated by application of said composition.

19. A method of claim 15, wherein said crop plant is defoliated by application of said composition.
